(19) United States
(12) Patent Application Publication
(10) Pub. No.: US 2008/0176028 A1
(43) Pub. Date: Jul. 24, 2008

(54) METHOD FOR MANUFACTURING HONEYCOMB STRUCTURE, AND HONEYCOMB STRUCTURE

(75) Inventors: Kazushige OHNO, Ibi-gun (JP); Masafumi Kunieda, Ibi-gun (JP); Takahiko Ido, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/940,175

(22) Filed: Nov. 14, 2007

(30) Foreign Application Priority Data
Nov. 16, 2006 (JP) PCT/JP2006/322876
Dec. 14, 2006 (JP) PCT/JP2006/324982

(51) Int. Cl. B32B 3/12; C04B 35/64

(52) U.S. Cl. 428/116; 264/630

(57) ABSTRACT

A method for manufacturing a honeycomb structure includes a molding step of manufacturing a pillar-shaped honeycomb molded body by using a raw material composition, and a firing step of carrying out a firing treatment on the honeycomb molded body to manufacture a honeycomb fired body. The pillar-shaped honeycomb molded body has a large number of cells disposed in substantially parallel with one another in a longitudinal direction with a cell wall therebetween. The raw material composition includes inorganic particles, at least one of inorganic fibers and inorganic whiskers, and an inorganic binder. The inorganic particles include secondary particles formed by an agglomeration of primary particles. An average particle diameter of the inorganic binder in the raw material composition is about 1/200 to about 1/40 of an average particle diameter of the inorganic particles.

### CROSS-REFERENCE TO RELATED APPLICATIONS

The present application claims priority under 35 U.S.C. §119 to PCT Application Nos. PCT/JP2006/322876, filed Nov. 16, 2006, and PCT/JP2006/324982, filed Dec. 14, 2006. The contents of these PCT applications are incorporated herein by reference in their entirety.

### BACKGROUND OF THE INVENTION

1. Field of the Invention

The present invention relates to a method for manufacturing a honeycomb structure, and a honeycomb structure.

2. Discussion of the Background

Conventionally, honeycomb catalysts formed by supporting catalyst components on a honeycomb structure, which are used for converting exhaust gases of vehicles, are being manufactured by supporting materials having a large specific surface area such as activated alumina and a catalyst metal such as platinum on the surface of a cordierite-based honeycomb structure having an integral structure and low thermal expansion. In addition, an alkaline earth metal such as barium (Ba) is supported on the honeycomb catalyst of this kind as a NOx adsorber in order to treat NOx in an atmosphere of excess oxygen like those in a lean burn engine and a diesel engine. Here, the more improvements in the performance of converting the exhaust gases require that the probability of contact of the exhaust gases with a catalyst noble metal and the NOx adsorber is increased. In order to do so, it is necessary that a carrier has a larger specific surface area, that a particle diameter of the noble metal is reduced, and that the noble metal particles are highly dispersed. And so, as a honeycomb structure containing a material having a large specific surface area, for example, honeycomb structures formed by extrusion-molding inorganic particles and inorganic fibers with an inorganic binder are known (for example, see Japanese Unexamined Patent Application Nos. 2005-218935 A, 2005-349378 A, and 05-213681 A). The contents of Japanese Unexamined Patent Application Nos. 2005-218935 A, 2005-349378 A, and 05-213681 A are incorporated herein by reference in their entirety.

### SUMMARY OF THE INVENTION

A method for manufacturing a honeycomb structure of the present invention includes manufacturing a pillar-shaped honeycomb molded body by using a raw material composition, and carrying out a firing treatment on the honeycomb molded body to manufacture a honeycomb fired body. The pillar-shaped honeycomb molded body has a large number of cells disposed in substantially parallel with one another in a longitudinal direction with a cell wall therebetween. The raw material composition includes inorganic particles, at least one of inorganic fibers and inorganic whiskers, and an inorganic binder. The inorganic particles include secondary particles formed by an agglomeration of primary particles. An average particle diameter of the inorganic binder in the raw material composition is about 1/200 to about 1/40 of an average particle diameter of the inorganic particles.

In the method for manufacturing a honeycomb structure of the present invention, an average particle diameter of the secondary particles is desirably about 0.5 to about 20 μm, and a specific surface area of the secondary particles is desirably about 50 to about 300 m²/g.

In the method for manufacturing a honeycomb structure of the present invention, the inorganic binder is desirably at least one kind selected from the group consisting of alumina sol, silica sol, titania sol, sepiolite and attapulgite.

In the method for manufacturing a honeycomb structure, a blending amount of the inorganic binder in the raw material composition is preferably about 10% to about 50% by weight as a solid content with respect to a total solid content of the inorganic particles, at least one of the inorganic fibers and the inorganic whiskers, and the inorganic binder.

In the method for manufacturing a honeycomb structure, the inorganic particles preferably include at least one of alumina, silica, zirconia, titania, ceria, mullite, and zeolite.

In the method for manufacturing a honeycomb structure, an average particle diameter of the primary particles of the inorganic particles is preferably about 5 to about 100 nm.

In the method for manufacturing a honeycomb structure, an average aspect ratio of the secondary particles is preferably about 1 to about 5.

In the method for manufacturing a honeycomb structure, a blending amount of the inorganic particles in the raw material composition is preferably about 30% to about 90% by weight with respect to a total solid content of the inorganic particles, at least one of the inorganic fibers and the inorganic whiskers, and the inorganic binder.

In the method for manufacturing a honeycomb structure, at least one of the inorganic fibers and the inorganic whiskers preferably include at least one of alumina, silica, silicon carbide, silica-alumina, glass, potassium titanate, and aluminum borate.

In the method for manufacturing a honeycomb structure, a blending amount of at least one of the inorganic fibers and the inorganic whiskers in the raw material composition is preferably about 3% to about 50% by weight with respect to a total solid content of the inorganic particles, at least one of the inorganic fibers and the inorganic whiskers, and the inorganic binder.

In the method for manufacturing a honeycomb structure, a firing temperature in the firing treatment is preferably about 500° C. to about 1200° C.

A honeycomb structure of the present invention includes a pillar-shaped honeycomb molded and fired body having a large number of cells disposed in substantially parallel with one another in a longitudinal direction with a cell wall therebetween. The pillar-shaped honeycomb molded and fired body is made from a raw material composition. The raw material composition includes inorganic particles, at least one of inorganic fibers and inorganic whiskers, and an inorganic binder. The inorganic particles include secondary particles formed by an agglomeration of primary particles. An average particle diameter of the inorganic binder in the raw material composition is about 1/200 to about 1/40 of an average particle diameter of the inorganic particles.

In the honeycomb structure of the present invention, an average particle diameter of the secondary particles is desirably about 0.5 to about 20 μm, and a specific surface area of the secondary particles is desirably about 50 to about 300 m²/g.

In the honeycomb structure of the present invention, the inorganic binder is desirably at least one kind selected from the group consisting of alumina sol, silica sol, titania sol, sepiolite and attapulgite.

In addition, a catalyst is desirably supported on the honeycomb structure of the present invention, and the catalyst desirably contains at least one kind selected from the group consisting of noble metals, alkali metals, alkaline earth metals, and oxides.

In the honeycomb structure, the inorganic particles preferably include at least one of alumina, silica, zirconia, titania, ceria, mullite, and zeolite.

In the honeycomb structure, an average particle diameter of the primary particles of the inorganic particles is preferably about 5 to about 100 nm.

In the honeycomb structure, at least one of the inorganic fibers and the inorganic whiskers preferably include at least one of alumina, silica, silicon carbide, silica-alumina, glass, potassium titanate, and aluminum borate.

In the honeycomb structure, the honeycomb molded and fired body is preferably manufactured by being fired at a temperature of about 500° C. to about 1200° C.

In the honeycomb structure, the honeycomb structure is preferably formed of one the honeycomb molded and fired body, or of a plurality of the honeycomb molded and fired bodies which are bound together.

In the honeycomb structure, a specific surface area per unit area of the honeycomb structure is preferably about 25000 m²/L to about 70000 m²/L.

Further, the honeycomb structure is desirably used for converting exhaust gases of vehicles.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings

FIG. 1(a) is a perspective view schematically showing one example of a honeycomb fired body manufactured by undergoing a firing step, and FIG. 1(b) is a perspective view schematically showing one example of a honeycomb structure according to an embodiment of the present invention formed by using the honeycomb fired body shown in FIG. 1(a).

FIG. 2 is a perspective view schematically showing another example of the honeycomb structure according to the embodiment of the present invention.

FIG. 3 is a graph showing a relationship between a ratio of an average particle diameter of an inorganic binder to an average particle diameter of inorganic particles and bending strength of each of honeycomb fired bodies manufactured in Examples and Comparative Examples.

### DESCRIPTION OF THE EMBODIMENTS

The embodiments will now be described with reference to the accompanying drawings, wherein like reference numerals designate corresponding or identical elements throughout the various drawings.

The method for manufacturing a honeycomb structure according to the embodiment of the present invention includes a molding step of manufacturing a pillar-shaped honeycomb molded body having a large number of cells disposed in substantially parallel with one another in a longitudinal direction with a cell wall therebetween by using a raw material composition including inorganic particles; at least one of inorganic fibers and inorganic whiskers; and an inorganic binder; and a firing step of carrying out a firing treatment on the honeycomb molded body to manufacture a honeycomb fired body. The inorganic particles include secondary particles formed by an agglomeration of primary particles, and an average particle diameter of the inorganic binder in the raw material composition is about 1/200 to about 1/40 of an average particle diameter of the inorganic particles.

The honeycomb structure according to the embodiment of the present invention is manufactured by undergoing a molding step of manufacturing a pillar-shaped honeycomb molded body having a large number of cells disposed in substantially parallel with one another in a longitudinal direction with a cell wall therebetween by using a raw material composition. The raw material composition includes inorganic particles, at least one of inorganic fibers and inorganic whiskers, and an inorganic binder. The method further includes a firing step of carrying out a firing treatment on the honeycomb molded body to manufacture a honeycomb fired body. The inorganic particles include secondary particles formed by an agglomeration of primary particles, and an average particle diameter of the inorganic binder in the raw material composition is about 1/200 to about 1/40 of an average particle diameter of the inorganic particles.

In the present application, a product obtained through the molding and firing steps as mentioned above is referred to as a pillar-shaped honeycomb molded and fired body or a honeycomb molded and fired body. The honeycomb structure according to an embodiment of the present invention may include a single honeycomb molded and fired body produced by the molding and firing steps, or a plurality of the honeycomb molded and fired bodies.

Conventionally, there have been cases where a sufficient specific surface area and strength to be used as a catalyst supporting carrier can not be secured.

In addition, in the honeycomb structure of this kind, there have been cases where, resulting from the insufficient specific surface area, the dispersibility of catalyst becomes low and a sufficient converting performance can not be enjoyed upon supporting the catalyst such as noble metals, and resulting from the insufficient strength, the honeycomb structure is readily destroyed.

In the method for manufacturing a honeycomb structure according to the embodiment of the present invention, a honeycomb structure having high strength and a large specific surface area can be manufactured since an inorganic binder having a prescribed average particle diameter is used.

In addition, the honeycomb structure according to the embodiment of the present invention has a large specific surface area and high strength, and can be suitably used as a catalyst supporting carrier.

First, the method for manufacturing a honeycomb structure according to the embodiment of the present invention will be described.

Hereinafter, the method for manufacturing a honeycomb structure according to the embodiment of the present invention will be described step by step.

(1) In the method for manufacturing a honeycomb structure according to the embodiment of the present invention, first, a molding step of manufacturing a pillar-shaped honeycomb molded body having a large number of cells disposed in substantially parallel with one another in a longitudinal direction with a cell wall therebetween by using a raw material composition. The raw material composition includes inorganic particles; at least one of inorganic fibers and inorganic whiskers; and an inorganic binder, is carried out.

As the raw material composition, a substance including inorganic particles; at least one of inorganic fibers and inorganic whiskers; and an inorganic binder, and as needed, further containing an organic binder, a dispersion medium and a forming auxiliary, which are appropriately added according to the moldability of the raw material composition, can be used.

In the method for manufacturing a honeycomb structure according to the embodiment of the present invention, as the inorganic particles, secondary particles formed by an agglomeration of primary particles is used, and as the inorganic binder, an inorganic binder having a lower limit of about 1/200 of an average particle diameter of the inorganic particles and an upper limit of about 1/40 of an average particle diameter of the inorganic particles is used. By using such an inorganic binder, a honeycomb structure having a large specific surface area and high strength may easily be manufactured by undergoing the manufacturing steps described later.

When an average particle diameter of the inorganic binder is about 1/200 or more and 1/40 or less of the average particle diameter of the inorganic particles, the strength of the manufactured honeycomb structure does not tend to become insufficient. The reason for this is presumably described as follows.

That is, in the method for manufacturing a honeycomb structure according to the embodiment of the present invention, presumably, the inorganic binder mainly plays a role of bonding the inorganic particles, the inorganic fibers and the inorganic whiskers, and the inorganic binder presumably exerts an adhesive function by interposing between the inorganic fibers (inorganic whiskers) and the inorganic particles to simultaneously come into contact with the inorganic fibers (inorganic whiskers) and the inorganic particles, or by interposing between each of the inorganic particles to simultaneously come into contact with the different inorganic particles.

Here, presumably, when the average particle diameter is about 1/200 or more of the average particle diameter of the inorganic particles, it becomes easy to simultaneously come into contact with the inorganic fibers (inorganic whiskers) and the inorganic particles and to simultaneously come into contact with the different inorganic particles, and therefore a sufficient adhesive strength may easily be obtained, and on the other hand, when the average particle diameter is about 1/40 or less of the average particle diameter of the inorganic particles, the number of points to be bonded increases and consequently the strength does not tend to become insufficient.

Furthermore, when an average particle diameter of the inorganic binder is about 1/40 or less of the average particle diameter of the inorganic particles, the specific surface area of the manufactured honeycomb structure is increased sufficiently, and it is advantageous when the honeycomb structure is used as a catalyst supporting carrier.

The reason for this is that since the average particle diameter of the inorganic binder is not too large, the inorganic binder does not tend to cover the surface of the inorganic particles so that it becomes easy to secure a large specific surface area in the manufactured honeycomb structure.

In addition, a desired average particle diameter of the inorganic binder is about 1/100 of the average particle diameter of the inorganic particles in the lower limit and about 1/50 of the average particle diameter of the inorganic particles in the upper limit.

As the inorganic binder, inorganic sols and clay binders can be used, and the specific examples of the inorganic sols include alumina sol, silica sol, titania sol and the like. The specific examples of the clay binders include clays having a double-chain structure such as white clay, kaolin, montmorillonite, sepiolite and attapulgite, and the like. These inorganic binders may be used alone or in combination of two or more kinds.

Among these binders, at least one kind selected from the group consisting of alumina sol, silica sol, titania sol, sepiolite and attapulgite is desirable.

A blending amount of the inorganic binder is, in terms of solid matter content, about 5% by weight as a desirable lower limit, about 10% by weight as a more desirable lower limit, and about 15% by weight as a furthermore desirable lower limit to the total amount of: the inorganic particles; at least one of the inorganic fibers and inorganic whiskers; and the solid matter of the inorganic binder (hereinafter, referred to as the total amount of essential raw materials). On the other hand, the blending amount of the inorganic binder is about 50% by weight as a desirable upper limit, about 40% by weight as a more desirable upper limit, and about 35% by weight as a furthermore desirable upper limit.

When the blending amount of the inorganic binder is about 5% by weight or more, the strength of the manufactured honeycomb structure does not tend to be deteriorated, and on the other hand, when the blending amount of the inorganic binder is about 50% by weight or less, the moldability of the raw material composition does not tend to be deteriorated.

In addition, the average particle diameter of the inorganic binder can be measured, for example, by the following method.

Specifically, when the inorganic binder is silica sol, first, the silica sol is dried, and BET specific surface area thereof is measured.

Next, assumed that silica particles in the silica sol are dense spherical particles, the BET specific surface area is determined from the following equation (1):

BET specific surface area=(6000/ρ)/particle diameter (1)

(in the equation, ρ is a true density (2.2 g/cm³) of silica)

Further, the average particle diameter of the inorganic binder can be also directly measured by using, for example, TEM (transmission electron microscope).

Examples of the inorganic particles include particles of alumina, silica, zirconia, titania, ceria, mullite, zeolite and the like. These particles may be used alone or in combination of two or more kinds.

Among these particles, alumina particles and ceria particles are particularly desirable.

A blending amount of the inorganic particles is about 30% by weight as a desirable lower limit to the total amount of essential raw materials, about 40% by weight as a more desirable lower limit, and about 50% by weight as a furthermore desirable lower limit.

On the other hand, the blending amount of the inorganic particles is about 90% by weight as a desirable upper limit, about 80% by weight as a more desirable upper limit, and about 75% by weight as a furthermore desirable upper limit.

When the blending amount of the inorganic particles is about 30% by weight or more, the specific surface area of the manufactured honeycomb structure does not tend to be reduced since the amount of the inorganic particles contributing to the increase of specific surface area is relatively increased, and therefore it becomes easier to highly disperse a catalyst component upon supporting the catalyst component on a catalyst supporting carrier. On the other hand, when the blending amount of the inorganic particles is about 90% by weight or less, the strength of the manufactured honeycomb structure does not tend to be deteriorated since the amounts of the inorganic binder, the inorganic fibers and the inorganic whiskers, contributing to the improvement of the strength, are relatively increased.

In addition, secondary particles of the inorganic particles mixed in the raw material composition desirably have an average particle diameter of about 0.5 to about 20 μm.

When the average particle diameter of the secondary particles is about 0.5 μm or more, the manufactured honeycomb structure does not tend to be densified, and therefore the permeability of gases does not tend to be low upon using the honeycomb structure as a catalyst supporting carrier, and on the other hand, when the average particle diameter of the secondary particles is about 20 μm or less, the specific surface area of the manufactured honeycomb structure does not tend to be reduced.

Incidentally, primary particles of the inorganic particles desirably have an average particle diameter of about 5 to about 100 nm.

In the present specification, the primary particles refer to particles forming a powder or agglomerate, and also refer to particles of a minimum unit existing without breaking a bond between molecules. In addition, the secondary particles refer to particles formed by the agglomeration of the primary particles.

In addition, the inorganic particles (secondary particles) desirably have a specific surface area of about 50 to about 300 m²/g.

The reason for this is that when the specific surface area is about 50 m²/g or more, the specific surface area of the manufactured honeycomb structure does not tend to be reduced, and on the other hand, when the specific surface area is more than about 300 m²/g, the specific surface area of the honeycomb structure is not increased so much even though the specific surface area of the inorganic particles (secondary particles) is increased. Thus, about 300 m²/g or less of the specific surface area is preferred.

In addition, in the method for manufacturing a honeycomb structure according to the embodiment of the present invention, the inorganic particles (secondary particles) desirably have an average aspect ratio of about 1 to about 5.

Examples of the inorganic fibers or inorganic whiskers include inorganic fibers and inorganic whiskers containing alumina, silica, silicon carbide, silica-alumina, glass, potassium titanate, aluminum borate, or the like.

These inorganic fibers or inorganic whiskers may be used alone or in combination of two or more kinds.

In addition, in the method for manufacturing a honeycomb structure according to the embodiment of the present invention, the inorganic fibers or the inorganic whiskers have an average aspect ratio of more than 5.

Further, an average aspect ratio of each of the inorganic fibers and inorganic whiskers is desirably about 10 to about 1000.

The total blending amount of at least one of the inorganic fibers and inorganic whiskers is about 3% by weight as a desirable lower limit to the total amount of essential raw materials, about 5% by weight as a more desirable lower limit, and about 8% by weight as a furthermore desirable lower limit. On the other hand, the blending amount of at least one of the inorganic fibers and inorganic whiskers is about 50% by weight as a desirable upper limit, about 40% by weight as a more desirable upper limit, and about 30% by weight as a furthermore desirable upper limit.

When the total blending amount of at least one of the inorganic fibers and inorganic whiskers is about 3% by weight or more, the strength of the manufactured honeycomb structure does not tend to be deteriorated, and on the other hand, when this total blending amount is about 50% by weight or less, since the amount of the inorganic particles contributing to the increase of specific surface area is relatively increased in the manufactured honeycomb structure, the specific surface area of the honeycomb structure may be increased, and therefore it becomes easier to highly disperse a catalyst component upon supporting the catalyst component on a catalyst supporting carrier.

In the raw material composition, an organic binder, a dispersion medium, and a forming auxiliary may be mixed.

The organic binder is not particularly limited, and examples of the binder include methyl cellulose, carboxymethyl cellulose, hydroxyethyl cellulose, polyethylene glycol, and the like.

These binders may be used alone or in combination of two or more kinds.

A blending amount of the organic binder is desirably about 1 to about 10 parts by weight to 100 parts by weight of the total of the inorganic particles, the inorganic fibers, the inorganic whiskers and the inorganic binder.

The dispersion medium is not particularly limited, and examples of the dispersion medium include water, organic solvents (benzene, and the like), alcohols (methanol, and the like) and the like.

The forming auxiliary is not particularly limited, and examples of the forming auxiliary include ethylene glycol, dextrin, fatty acid, fatty acid soap, polyalcohol and the like.

A method for preparing the raw material composition is not particularly limited, and it is preferred to conduct at least one of mixing and kneading a raw material, and the raw material may be mixed with, for example, a mixer or an attritor, or may be kneaded well with a kneader.

Next, the raw material composition is extrusion-molded to manufacture a pillar-shaped honeycomb molded body having a large number of cells disposed in substantially parallel with one another in a longitudinal direction with a cell wall therebetween.

(2) A drying step is carried out as needed on the honeycomb molded body.

The drying step can be carried out with, for example, a microwave drying apparatus, a hot-air drying apparatus, a dielectric drying apparatus, a reduced pressure drying apparatus, a vacuum drying apparatus, a freeze drying apparatus, and the like.

(3) A degreasing step is carried out, as needed, on the honeycomb molded body dried as needed.

In this case, degreasing conditions are not particularly limited and appropriately selected according to kinds and amounts of organic substances contained in the molded body, and about 400° C. and about 2 hours are desirable as these conditions.

(4) Next, a firing step of carrying out a firing treatment on the honeycomb molded body dried and degreased as needed to manufacture a honeycomb fired body is carried out.

A firing temperature in the firing treatment is not particularly limited, and a temperature of about 500 to about 1200° C. is desirable, and a temperature of about 600 to about 1000° C. is more desirable.

When the firing temperature is about 500° C. or more, an adhesive function of the inorganic binder tends to develop and sintering of the inorganic particles also tends to proceed, and therefore the strength of the manufactured honeycomb structure does not tend to be deteriorated, and when it is about 1200° C. or less, the sintering of the inorganic particles does not proceed too excessively and the specific surface area per unit volume of the manufactured honeycomb structure is increased, and therefore it becomes easier to sufficiently highly disperse a catalyst component to be supported on a honeycomb structure upon using the honeycomb structure as a catalyst supporting carrier.

By undergoing these steps, a pillar-shaped honeycomb fired body having a large number of cells disposed in substantially parallel with one another in a longitudinal direction with a cell wall therebetween can be manufactured.

The honeycomb fired body itself, manufactured by undergoing these steps, may be provided as a honeycomb structure according to one embodiment of the present invention, and in the method for manufacturing a honeycomb structure according to the embodiment of the present invention, the overall steps can be terminated at the firing step.

Further, a sealing material layer (coat layer) is formed on the periphery of the honeycomb fired body manufactured by the above-mentioned manufacturing method, and the resulting honeycomb fired body may be used as a finished product of the honeycomb structure. The honeycomb structure including one honeycomb fired body is also referred to as an integral honeycomb structure in the following.

Here, a method for forming the sealing material layer (coat layer) is similar to a method for forming a sealing material layer (coat layer) on the periphery of a honeycomb block upon manufacturing the honeycomb structure by binding a plurality of the honeycomb fired bodies together to form the honeycomb block to be described later.

Further, in the method for manufacturing a honeycomb structure according to the embodiment of the present invention, the honeycomb structure may be manufactured by the above-mentioned method, and then binding a plurality of these honeycomb fired bodies together to form the honeycomb block.

In this case, the following method may be used.

Hereinafter, the honeycomb structure formed by binding a plurality of the honeycomb fired bodies together is also referred to as an aggregated honeycomb structure.

That is, a sealing material paste to become a sealing material layer (adhesive layer) is applied to the obtained honeycomb fired body to bind the honeycomb fired body in sequence, and thereafter the sealing material paste is dried and solidified to manufacture an aggregate of the honeycomb fired bodies having a prescribed size bound by interposing the sealing material layer (adhesive layer).

In addition, a prescribed number of the honeycomb fired bodies are piled up by interposing a spacer, and then a sealing material paste is filled into a gap between the honeycomb fired bodies, and thereafter the sealing material paste is dried and solidified to manufacture an aggregate of the honeycomb fired bodies having a prescribed size bound by interposing the sealing material layer (adhesive layer).

The sealing material paste for forming an adhesive layer is not particularly limited, and for example, a mixture of an inorganic binder and ceramic particles, a mixture of an inorganic binder and inorganic fibers, or a mixture of an inorganic binder, ceramic particles and inorganic fibers can be used.

In addition, an organic binder may be added to these sealing material pastes.

The organic binder is not particularly limited, and examples of the binder include polyvinyl alcohol, methyl cellulose, ethyl cellulose, carboxymethyl cellulose and the like.

These binders may be used alone or in combination of two or more kinds.

A thickness of the sealing material layer (adhesive layer) is desirably about 0.5 to about 5 mm.

When the thickness of the sealing material layer (adhesive layer) is about 0.5 mm or more, sufficient adhesive strength may easily be obtained, and when the thickness of the sealing material layer (adhesive layer) is about 5 mm or less, since the sealing material layer (adhesive layer) is a portion not functioning as a catalyst supporting carrier, the specific surface area per unit volume of the honeycomb structure does not tend to be reduced, and therefore it becomes easier to sufficiently highly disperse a catalyst component upon supporting the catalyst component on a catalyst supporting carrier.

Further, when the thickness of the sealing material layer (adhesive layer) is about 5 mm or less, pressure loss does not tend to become high.

Here, the number of the honeycomb fired bodies to be bound may be appropriately determined according to the size of the honeycomb structure. In addition, an aggregate of the honeycomb fired bodies formed by binding the honeycomb fired bodies together by interposing the sealing material layer (adhesive layer) is appropriately cut and polished as needed to form a honeycomb block.

Next, a sealing material layer (coat layer) is formed by applying a sealing material paste for forming a coat layer onto the periphery of the honeycomb block as needed, and drying and solidifying the sealing material paste.

By forming the sealing material layer (coat layer), the periphery of the honeycomb block can be protected, and consequently the strength of the honeycomb structure may easily be improved.

The sealing material paste for forming the coat layer is not particularly limited, and it may be made from the same materials as of the sealing material paste for forming the adhesive layer, or may be made from the different materials from those of the sealing material paste for forming the adhesive layer.

In addition, when the sealing material paste for forming the coat layer is made from the same materials as of the sealing material paste for forming the adhesive layer, blending ratios of the composition of both the sealing material pastes may be the same as or different from each other.

A thickness of the sealing material layer (coat layer) is not particularly limited, and this thickness is desirably about 0.1 to about 2 mm. When the thickness is about 0.1 mm or more, the periphery can be protected fully and the strength may easily be improved, and when the thickness is about 2 mm or less, the specific surface area per unit volume of the honeycomb structure does not tend to be reduced, and therefore it becomes easier to sufficiently highly disperse a catalyst component upon supporting the catalyst component on a catalyst supporting carrier.

In addition, in the method for manufacturing a honeycomb structure according to the embodiment of the present invention, it is preferred to calcine the honeycomb fired bodies after binding a plurality of the honeycomb fired bodies together by interposing the sealing material layer (adhesive layer) (however, when a sealing material layer (coat layer) is provided, calcine them after forming the coat layer).

The reason for this is that when an organic binder is contained in the sealing material layer (adhesive layer) and the sealing material layer (coat layer), the organic binder can be degreased and removed by calcination.

The conditions of the calcination are appropriately determined according to kinds and amounts of organic substances contained, and about 700° C. and about 2 hours are desirable as these conditions.

Next, the honeycomb structure according to the embodiment of the present invention will be described.

In the present specification, a pillar shape includes arbitrary pillar shapes such as a round pillar shape, a cylindroid shape, and a polygonal pillar shape.

The honeycomb structure according to the embodiment of the present invention is a honeycomb structure manufactured by undergoing at least the molding step and the firing step. The inorganic particles include the secondary particles formed by the agglomeration of the primary particles, and the average particle diameter of the inorganic binder in the raw material composition is about 1/200 to about 1/40 of the average particle diameter of the inorganic particles.

Accordingly, the honeycomb structure according to the embodiment of the present invention can be manufactured by use of the above-mentioned method for manufacturing a honeycomb structure according to the embodiment of the present invention.

Hereinafter, the configuration of the honeycomb structure according to the embodiment of the present invention will be described referring to drawings.

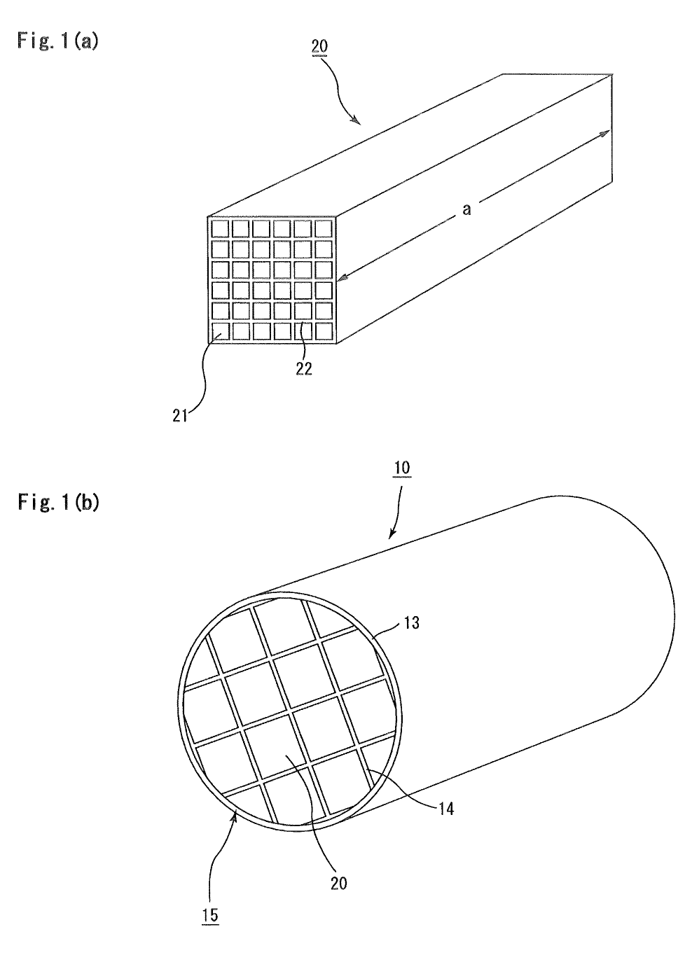

FIG. 1(a) is a perspective view schematically showing one example of a honeycomb fired body (one example of a honeycomb structure) manufactured by undergoing a firing step, and FIG. 1(b) is a perspective view schematically showing another example of a honeycomb structure according to the embodiment of the present invention formed by using the honeycomb fired body shown in FIG. 1(a).

As shown in FIG. 1(a), a honeycomb fired body 20 has a square pillar shape, and has a large number of cells 21 disposed in substantially parallel with one another in a longitudinal direction (the direction shown by an arrow a in FIG. 1(a)) with a cell wall 22 therebetween.

As shown in FIG. 1(b), in a honeycomb structure according to the embodiment 10 of the present invention, a plurality of the honeycomb fired bodies 20 shown in FIG. 1(a) are bound together by interposing a sealing material layer (adhesive layer) 14 to configure a ceramic block 15, and a sealing material layer (coat layer) 13 is formed on the periphery thereof.

In the honeycomb fired body, a thickness of the cell wall is not particularly limited, and the thickness of the cell wall has a desirable lower limit of about 0.05 mm, a more desirable lower limit of about 0.10 mm, and a particularly desirable lower limit of about 0.15 mm. On the other hand, the thickness of the cell wall has a desirable upper limit of about 0.35 mm, a more desirable upper limit of about 0.30 mm, and a particularly desirable upper limit of about 0.25 mm.

When the thickness of the cell wall is about 0.05 mm or more, the strength of the honeycomb fired body does not tend to be deteriorated, and on the other hand, when the thickness of the cell wall is about 0.35 mm or less, the performance of converting the exhaust gases does not tend to be deteriorated since a contacting area with the exhaust gases does not tend to be reduced, and the gases tends to permeate deeply into a catalyst supporting carrier and therefore the catalyst supported on the inner surface in the cell wall may easily come into contact with the gases upon using the honeycomb structure as a catalyst supporting carrier for converting the exhaust gases.

In addition, a cell density of the honeycomb fired body has a desirable lower limit of about 15.5 pcs/cm² (about 100 cpsi), a more desirable lower limit of about 46.5 pcs/cm² (about 300 cpsi), and a furthermore desirable lower limit of about 62 pcs/cm² (about 400 cpsi). On the other hand, the cell density has a desirable upper limit of about 186 pcs/cm² (about 1200 cpsi), a more desirable upper limit of about 170.5 pcs/cm² (about 1100 cpsi), and a furthermore desirable upper limit of about 155 pcs/cm² (about 1000 cpsi).

When the cell density is about 15.5 pcs/cm² or more, an area of the cell wall contacting the exhaust gases within the honeycomb fired body does not tend to be reduced upon using the honeycomb structure as a catalyst supporting carrier for converting the exhaust gases, and when the cell density is about 186 pcs/cm² or less, pressure loss does not tend to become high and also manufacturing of the honeycomb fired body may become easier.

In addition, desirably, a cross-sectional area of the honeycomb fired body in the direction perpendicular to the longitudinal direction of the honeycomb fired body has a lower limit of about 5 cm² and an upper limit of about 50 cm², and particularly when the honeycomb structure is formed by binding a plurality of the honeycomb fired bodies together, the cross-sectional area is desirably within the above-mentioned range.

When the cross-sectional area is about 5 cm² or more, since an area of the sealing material layer (adhesive layer), with which a plurality of the honeycomb fired bodies are bound, is not relatively increased in a cross section perpendicular to the longitudinal direction of the honeycomb structure, an area on which a catalyst can be supported does not tend to be relatively reduced upon using the honeycomb structure as a catalyst supporting carrier. On the other hand, when the cross-sectional area is about 50 cm² or less, it becomes easier to sufficiently suppress thermal stress generated in the honeycomb fired body since the honeycomb fired body does not become too large.

The cross-sectional area has a more desirable lower limit of about 6 cm², and a particularly desirable lower limit of about 8 cm², and a more desirable upper limit of about 40 cm², and a particularly desirable upper limit of about 30 cm².

A shape of a cross section perpendicular to the longitudinal direction of a cell formed in the honeycomb fired body is not particularly limited, and an approximate triangle or an approximate hexagon may be used other than a rectangle like the honeycomb fired body shown in FIG. 1(a).

Further, when the sealing material layer (adhesive layer) and the sealing material layer (coat layer) are formed in the honeycomb structure, desirably, a ratio of the total cross-sectional area of the honeycomb fired bodies to the cross-sectional area of the honeycomb structure is about 90% or more in a cross section perpendicular to the longitudinal direction of the honeycomb structure. The reason for this is that when this ratio is about 90% or more, the specific surface area of the honeycomb structure does not tend to be reduced.

In addition, desirably, the specific surface area per unit area of the honeycomb structure according to the embodiment of the present invention is about 25000 m²/L (litter) or more.

The reason for this is that when the specific surface area is within the above range, it becomes easy to sufficiently broadly support and disperse a catalyst on the whole honeycomb structure.

Incidentally, a desirable upper limit of the specific surface area is about 70000 m²/L in consideration of the limit of dispersion of the catalyst (for example, platinum).

It is more desirable that a bending strength of the honeycomb structure is higher, and specifically, it is desirable that the bending strength is about 3.0 MPa or more when the honeycomb fired body has a rectangular pillar shape of about 37 mm×about 37 mm×about 75 mm.

The reason for this is that a possibility of destruction of the honeycomb structure due to thermal stress and the like generated upon using the honeycomb structure becomes less.

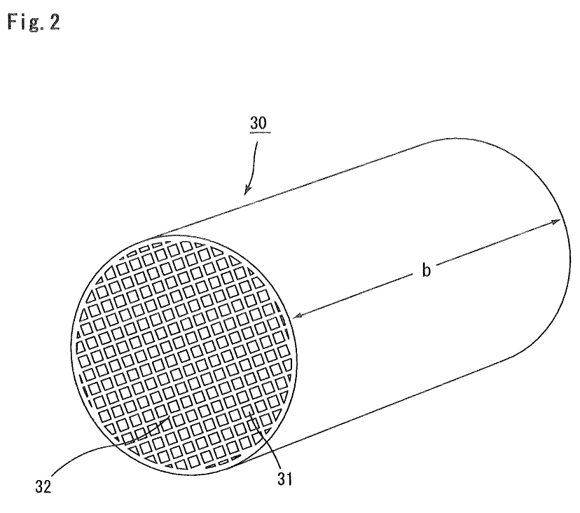

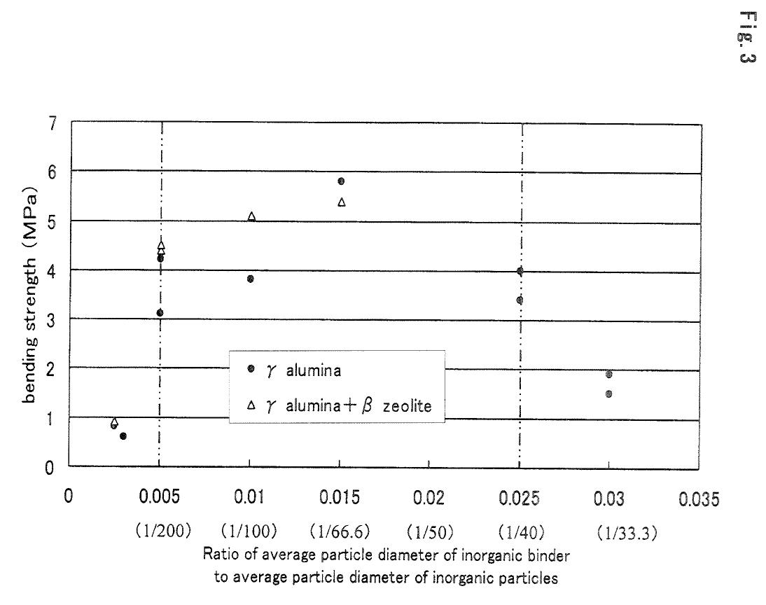

In addition, the honeycomb structure according to the embodiment of the present invention is not limited to an aggregated honeycomb structure as shown in FIG. 1(b), and it may be an integral honeycomb structure as shown in FIG. 2.

FIG. 2 is a perspective view schematically showing another example of the honeycomb structure according to the embodiment of the present invention.

A honeycomb structure 30 shown in FIG. 2 is formed by a honeycomb fired body having a pillar shape, and having a large number of cells 31 (in the direction shown by an arrow b in FIG. 2) disposed in substantially parallel with one another in a longitudinal direction with a cell wall 32 therebetween.

Further, in the integral honeycomb structure of this kind, a sealing material layer (coat layer) may be formed on the periphery of the honeycomb fired body.

A catalyst is desirably supported on the honeycomb structure according to the embodiment of the present invention having such a configuration. The reason for this is that the honeycomb structure according to the embodiment of the present invention can be suitably used as a catalyst supporting carrier.

The catalyst is not particularly limited, and examples of the catalyst include noble metals, alkali metals, alkaline earth metals, oxides and the like. These may be used alone or in combination of two or more kinds.

Examples of the noble metals include platinum, palladium, rhodium and the like, examples of the alkali metals include potassium, sodium and the like, examples of the alkaline earth metals include barium and the like, and examples of the oxides include perovskite (La_{0.75}K_{0.25}MnO₃ and the like), CeO₂ and the like.

The applications of the honeycomb structure on which a catalyst is supported as described above is not particularly limited, and the honeycomb structure can be used for, for example, the so-called three-way catalyst for converting the exhaust gases of automobiles or a NOx adsorbing catalyst.

Incidentally, a timing of supporting a catalyst is not particularly limited, and the catalyst may be supported after manufacturing the honeycomb structure, or may be supported on inorganic particles in the raw material composition.

Further, a method for supporting a catalyst is not particularly limited, and the catalyst can be supported, for example, by an impregnation method.

Here, the honeycomb structure according to the embodiment of the present invention has been described with examples mainly using the honeycomb structure as a catalyst supporting carrier, but the application of the honeycomb structure of the present invention is not limited to the catalyst supporting carrier, and the honeycomb structure can be also used for the applications without the catalyst components supported on, such as adsorbents which adsorb gas components or liquid components.

### EXAMPLES

Hereinafter, the present invention will be described in more detail by way of Examples, but the present invention is not limited to these Examples.

### Example 1

(1) 2250 g of γ alumina particles (an average particle diameter of secondary particles is 1 μm) as inorganic particles, 680 g of aluminum borate whiskers (fiber diameters are 0.5 to 1 μm, fiber lengths are 10 to 30 μm) as inorganic fibers, and 2600 g of silica sol (an average particle diameter is 10 nm, solid concentration is 30% by weight) as an inorganic binder were mixed, and further to the resulting mixture, 320 g of methyl cellulose as an organic binder, 290 g of UNILUB (manufactured by NOF Corp.) as a lubricant, and 225 g of glycerin (manufactured by NOF Corp.) as a plasticizer were added, and the resulting mixture was further mixed and kneaded to prepare a raw material composition. Next, this raw material composition was extrusion-molded with an extrusion-molding machine to manufacture a honeycomb molded body.

Here, an average particle diameter of the inorganic binder is 1/100 of the average particle diameter of the inorganic particles.

(2) Next, the honeycomb molded body was dried well with a microwave drying apparatus and a hot-air drying apparatus, and further kept at 400° C. for 2 hours to be degreased.

Thereafter, a firing treatment was carried out on the honeycomb molded body while keeping the honeycomb molded body at 900° C. for 2 hours to manufacture a honeycomb fired body having a rectangular pillar shape (37 mm×37 mm×75 mm), a cell density of 93 pcs/cm² (600 cpsi), a thickness of a cell wall of 0.2 mm, with a cross-sectional shape of the cells formed into a rectangular (square) shape.

### Examples 2 to 6

Honeycomb fired bodies were manufactured by following the same procedure as in Example 1 except for using γ alumina particles (secondary particles) having average particle diameters shown in Table 1 as inorganic particles and silica sol (solid concentration is 30% by weight) having average particle diameters shown in Table 1 as an inorganic binder used upon preparing a raw material composition.

Here, ratios of the average particle diameters of the inorganic binder to the average particle diameters of the inorganic particles are shown in Table 1.

### Example 7

A honeycomb fired body was manufactured by following the same procedure as in Example 1 except for using mixed particles of 50% by weight of γ alumina particles (an average particle diameter of secondary particles is 2 μm) and 50% by weight of β zeolite particles (an average particle diameter of secondary particles is 2 μm) in place of the γ alumina particles as inorganic particles.

### Examples 8 to 10

Honeycomb fired bodies were manufactured by following the same procedure as in Example 7 except for using mixed particles of 50% by weight of γ alumina particles (secondary particles) having average particle diameters shown in Table 1 and 50% by weight of β zeolite particles (secondary particles) having average particle diameters shown in Table 1 as inorganic particles, and silica sol (solid concentration is 30% by weight) having average particle diameters shown in Table 1 as an inorganic binder used upon preparing a raw material composition. Although only one value is shown as each of average particle diameters of inorganic particles in Table 1, in the present examples, both γ alumina particles and β zeolite particles have average particle diameters of this value.

Here, ratios of the average particle diameters of the inorganic binder to the average particle diameters of the inorganic particles are shown in Table 1.

### Comparative Examples 1 to 4

Honeycomb fired bodies were manufactured by following the same procedure as in Example 1 except for using γ alumina particles (secondary particles) having average particle diameters shown in Table 1 as inorganic particles and silica sol (solid concentration is 30% by weight) having average particle diameters shown in Table 1 as an inorganic binder used upon preparing a raw material composition.

Here, ratios of the average particle diameters of the inorganic binder to the average particle diameters of the inorganic particles are shown in Table 1.

### Comparative Examples 5

Honeycomb fired body was manufactured by following the same procedure as in Example 7 except for using mixed particles of 50% by weight of γ alumina particles (an average particle diameter of secondary particles is 4 μm) and 50% by weight of β zeolite particles (an average particle diameter of secondary particles is 4 μm) as inorganic particles, and silica sol (solid concentration is 30% by weight) having average particle diameter of 10 μm as an inorganic binder used upon preparing a raw material composition.

Here, a ratio of the average particle diameter of the inorganic binder to the average particle diameter of the inorganic particles is 1/400.

Evaluation of Honeycomb Fired Bodies

On the honeycomb fired bodies manufactured in Examples and Comparative Examples, bending strength and specific surface area were measured according to the following methods. The results are shown in Table 1.

(Measurement of Bending Strength)

A three-point bending test was carried out in the conditions of a bending span distance of 50 mm and a bending speed of 0.5 mm/min by using INSTRON 5582, referring to JIS R 1601 to measure the bending strength of the honeycomb fired bodies of Examples and Comparative Examples.

The results are shown in Table 1.

The contents of JIS R 1601 are incorporated herein by reference in their entirety.

(Specific Surface Area)

First, a BET specific surface area A (m²/g) per unit weight of each of the honeycomb fired bodies was measured. The BET specific surface area was measured by one-point method with N₂ gas according to JIS R 1626 (1996) stipulated in the Japanese Industrial Standards by using a BET measuring apparatus (Micromeritics FlowSorb II-2300, manufactured by Shimadzu Corp.). A sample cut out into a cylindrical small piece (15 mm in diameter×15 mm in height) was used for measurement.

Next, an apparent density B (g/L) of each of the honeycomb fired bodies was calculated from a weight and a volume of the outside shape of each of the honeycomb fired bodies, and the specific surface area S (m²/L) of each of the honeycomb fired bodies was determined from the following equation (2). The results are shown in Table 1.

S(m²/L)=A×B (2)

Incidentally, this specific surface area of each of the honeycomb fired bodies refers to a specific surface area per an apparent volume of each of the honeycomb fired bodies.

The contents of JIS R 1626 (1996) are incorporated herein by reference in their entirety.

TABLE 1

| | | Average | | | | |
|---|---|---|---|---|---|---|
| | | particle | Average | Ratio of average | | |
| | | diameter of | particle | particle diameter | | |
| | | inorganic | diameter | of inorganic | | |
| | | particles | of | binder to average | | Specific |
| | | (secondary | inorganic | particle diameter | Bending | surface |
| | Inorganic | particles) | binder | of inorganic | strength | area |
| | particles | (μm) | (nm) | particles | (MPa) | (m²/L) |
| Example 1 | γ alumina | 1 | 10 | 1/100 | 3.8 | 43800 |
| Example 2 | γ alumina | 1 | 5 | 1/200 | 3.1 | 44800 |
| Example 3 | γ alumina | 1 | 25 | 1/40 | 3.4 | 42000 |
| Example 4 | γ alumina | 2 | 30 | 3/200 (1/66.6) | 5.8 | 43800 |
| Example 5 | γ alumina | 2 | 10 | 1/200 | 4.2 | 45200 |
| Example 6 | γ alumina | 2 | 50 | 1/40 | 4.0 | 42500 |
| Example 7 | γ alumina + | 2 | 30 | 3/200 (1/66.6) | 5.4 | 40400 |
| | β zeolite | | | | | |
| Example 8 | γ alumina + | 4 | 40 | 1/100 | 5.1 | 40200 |
| | β zeolite | | | | | |
| Example 9 | γ alumina + | 4 | 20 | 1/200 | 4.4 | 41200 |
| | β zeolite | | | | | |
| Example 10 | γ alumina + | 8 | 40 | 1/200 | 4.5 | 41500 |
| | β zeolite | | | | | |
| Comparative | γ alumina | 1 | 3 | 3/1000 (1/333) | 0.6 | 45100 |
| Example 1 | | | | | | |
| Comparative | γ alumina | 1 | 30 | 3/100 (1/33.3) | 1.5 | 38200 |
| Example 2 | | | | | | |
| Comparative | γ alumina | 2 | 5 | 1/400 | 0.8 | 45400 |
| Example 3 | | | | | | |
| Comparative | γ alumina | 2 | 60 | 3/100 (1/33.3) | 1.9 | 38500 |
| Example 4 | | | | | | |
| Comparative | γ alumina + | 4 | 10 | 1/400 | 0.9 | 42000 |
| Example 5 | β zeolite | | | | | |

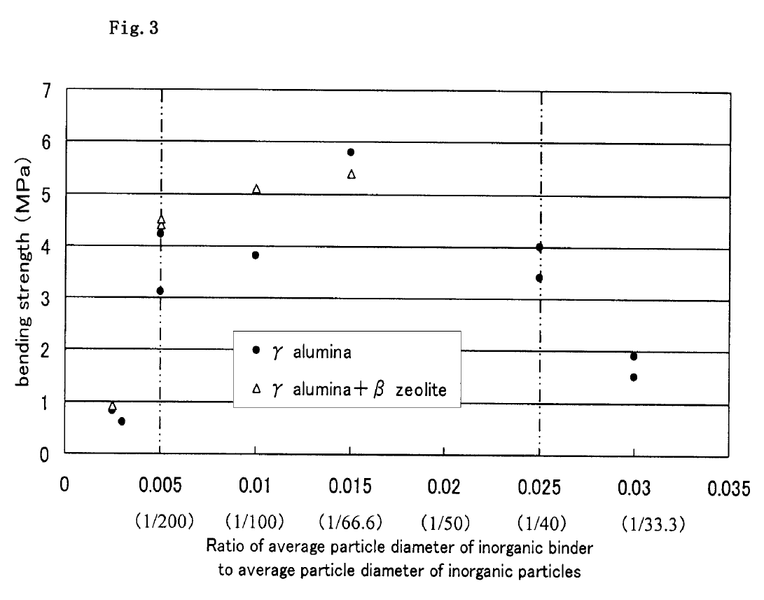

As is apparent from the results shown in Table 1 and FIG. 3, it became evident that by using the inorganic binder having an average particle diameter of about 1/40 or less of the average particle diameter of the inorganic particles, a honeycomb fired body (honeycomb structure) having a large specific surface area can be manufactured, and by using the inorganic binder having an average particle diameter of about 1/200 to about 1/40 of the average particle diameter of the inorganic particles, a honeycomb fired body (honeycomb structure) having high strength can be manufactured. Incidentally, FIG. 3 is a graph showing a relationship between a ratio of an average particle diameter of the inorganic binder to an average particle diameter of inorganic particles and bending strength of each of the honeycomb fired bodies manufactured in Examples and Comparative Examples.

In addition, in Examples and Comparative Examples described above, one honeycomb fired body was manufactured and this honeycomb fired body was evaluated as a honeycomb structure, but in the case where an aggregated honeycomb structure as shown in FIGS. 1(a) and 1(b) is manufactured by using a plurality of the honeycomb fired bodies, similar results are presumably obtained.

Obviously, numerous modifications and variations of the present invention are possible in light of the above teachings. It is therefore to be understood that within the scope of the appended claims, the invention may be practiced otherwise than as specifically described herein.

1. A method for manufacturing a honeycomb structure, comprising:
manufacturing a pillar-shaped honeycomb molded body having a large number of cells disposed in substantially parallel with one another in a longitudinal direction with a cell wall therebetween by using a raw material composition comprising:
inorganic particles;
at least one of inorganic fibers and inorganic whiskers; and
an inorganic binder; and
carrying out a firing treatment on said honeycomb molded body to manufacture a honeycomb fired body,
wherein said inorganic particles comprise secondary particles formed by an agglomeration of primary particles, and
an average particle diameter of said inorganic binder in said raw material composition is about 1/200 to about 1/40 of an average particle diameter of said inorganic particles.

2. The method for manufacturing a honeycomb structure according to claim 1,
wherein an average particle diameter of said secondary particles is about 0.5 to about 20 μm.

3. The method for manufacturing a honeycomb structure according to claim 1,
wherein a specific surface area of said secondary particles is about 50 to about 300 m²/g.

4. The method for manufacturing a honeycomb structure according to claim 1,
wherein said inorganic binder is at least one kind selected from the group consisting of alumina sol, silica sol, titania sol, sepiolite and attapulgite.

5. The method for manufacturing a honeycomb structure according to claim 1,
wherein a blending amount of the inorganic binder in the raw material composition is about 10% to about 50% by weight as a solid content with respect to a total solid content of the inorganic particles, at least one of the inorganic fibers and the inorganic whiskers, and the inorganic binder.

6. The method for manufacturing a honeycomb structure according to claim 1,
wherein the inorganic particles comprise at least one of alumina, silica, zirconia, titania, ceria, mullite, and zeolite.

7. The method for manufacturing a honeycomb structure according to claim 1,
wherein an average particle diameter of the primary particles of the inorganic particles is about 5 to about 100 nm.

8. The method for manufacturing a honeycomb structure according to claim 1,
wherein an average aspect ratio of the secondary particles is about 1 to about 5.

9. The method for manufacturing a honeycomb structure according to claim 1,
wherein a blending amount of the inorganic particles in the raw material composition is about 30% to about 90% by weight with respect to a total solid content of the inorganic particles, at least one of the inorganic fibers and the inorganic whiskers, and the inorganic binder.

10. The method for manufacturing a honeycomb structure according to claim 1,
wherein at least one of the inorganic fibers and the inorganic whiskers comprise at least one of alumina, silica, silicon carbide, silica-alumina, glass, potassium titanate, and aluminum borate.

11. The method for manufacturing a honeycomb structure according to claim 1,
wherein a blending amount of at least one of the inorganic fibers and the inorganic whiskers in the raw material composition is about 3% to about 50% by weight with respect to a total solid content of the inorganic particles, at least one of the inorganic fibers and the inorganic whiskers, and the inorganic binder.

12. The method for manufacturing a honeycomb structure according to claim 1,
wherein a firing temperature in the firing treatment is about 500° C. to about 1200° C.

13. A honeycomb structure manufactured comprising:
a pillar-shaped honeycomb molded and fired body having a large number of cells disposed in substantially parallel with one another in a longitudinal direction with a cell wall therebetween, the pillar-shaped honeycomb molded and fired body being made from a raw material composition comprising:
inorganic particles having secondary particles formed by an agglomeration of primary particles;
at least one of inorganic fibers and inorganic whiskers; and
an inorganic binder having an average particle diameter which is about 1/200 to about 1/40 of an average particle diameter of said inorganic particles.

14. The honeycomb structure according to claim 13,
wherein an average particle diameter of said secondary particles is about 0.5 to about 20 μm.

15. The honeycomb structure according to claim 13,
wherein a specific surface area of said secondary particles is about 50 to about 300 m²/g.

16. The honeycomb structure according to claim 13,
wherein said inorganic binder is at least one kind selected from the group consisting of alumina sol, silica sol, titania sol, sepiolite and attapulgite.

17. The honeycomb structure according to claim 13,
wherein a catalyst is supported on said honeycomb structure.

18. The honeycomb structure according to claim 17,
wherein said catalyst contains at least one kind selected from the group consisting of noble metals, alkali metals, alkaline earth metals, and oxides.

19. The honeycomb structure according to claim 13,
wherein the inorganic particles comprise at least one of alumina, silica, zirconia, titania, ceria, mullite, and zeolite.

20. The honeycomb structure according to claim 13,
wherein an average particle diameter of the primary particles of the inorganic particles is about 5 to about 100 nm.

21. The honeycomb structure according to claim 13,
wherein at least one of the inorganic fibers and the inorganic whiskers comprise at least one of alumina, silica, silicon carbide, silica-alumina, glass, potassium titanate, and aluminum borate.

22. The honeycomb structure according to claim 13,
wherein the honeycomb molded and fired body is manufactured by being fired at a temperature of about 500° C. to about 1200° C.

23. The honeycomb structure according to claim 13,
wherein the honeycomb structure is formed of one the honeycomb molded and fired body, or of a plurality of the honeycomb molded and fired bodies which are bound together.

24. The honeycomb structure according to claim 13,
wherein a specific surface area per unit area of the honeycomb structure is about 25000 m²/L to about 70000 m²/L.

25. The honeycomb structure according to claim 13,
wherein said honeycomb structure is used for converting exhaust gases of vehicles.
